(19) United States
(12) Patent Application Publication
(10) Pub. No.: US 2010/0300227 A1
(43) Pub. Date: Dec. 2, 2010

(54) DRIVE SYSTEM COMPRISING COMPONENTS THAT CAN BE COMBINED TO FORM MODULES

(76) Inventor: Robert Schuele, Boeblingen (DE)

Correspondence Address: BROOKS KUSHMAN P.C., 1000 TOWN CENTER, TWENTY-SECOND FLOOR, SOUTHFIELD, MI, 48075, US

(21) Appl. No.: 12/745,152

(22) PCT Filed: Nov. 27, 2008
(86) PCT No.: PCT/DE08/01962

§ 371 Date: May 27, 2010

(30) Foreign Application Priority Data
Nov. 29, 2007 (DE) 10 2007 058 809.9

(51) Int. Cl. F16H 57/00

(52) U.S. Cl. 74/411.5

(57) ABSTRACT

The invention relates to a drive system comprising components that can be combined to form modules, forming a plurality of drives and outputs having different properties, each combination of the components respectively containing a lower housing part, at least one motor, and a gear reduction consisting of a pinion and a toothed wheel. The drive system according to the invention is characterised by the following combinations of features: a) in order to create a basic drive, the toothed wheel comprises a reversible thread with a non-self-locking pitch and positive locking for an output, b) a control spring, a brake spring, an output, and a brake ring are used to produce a load moment block with a linear correlation between the braking moment (Mb) and the friction coefficient (μ), and c) furthermore, different upper housing parts can be arranged on the drive system in order to create different drives and outputs.

The present invention relates to a novel drive system comprising components which can be combined in a modular manner and from which a multiplicity of drives and outputs with different properties can be implemented, each combination of the components containing in each case a housing lower part and at least one motor, and a reduction gear consisting of a pinion and of a gearwheel.

Drive systems of this type are employed predominantly in the automobile industry, for example on electrically adjustable seats, tailgates, roller blinds, windows or doors. The drives are especially suitable when these loads to be driven have to be secured by means of fastenings or when lifting mechanisms are concerned, and particularly when the system weight or the operating costs are especially important.

For the drive of tailgates and closures in automobiles, DE102005048129B4 discloses a drive which can be extended in a modular manner by means of a differential. This drive system possesses, above the self-locking thread in the crown wheel, a load moment lock for the translational movement of a spindle. The volute spring used is intended to make it possible to use a drive of this type for central locking systems. Since the thread in the crown wheel is of the self-locking type and the volute spring can be wound up only in a limited number of turns, translational actuating travel that is customary for a central locking drive cannot be implemented by means of this system. Moreover, for safety reasons, in a central locking system the spindle must be reversible. The closing spring of a locking system can then reverse the unlocking drive even when its volute spring is absent, is somewhat jammed or is broken.

A drive which opens a closure in the vehicle must be mechanically self-resetting, so that a fault or failure of the control electronics cannot lead to a half-opened closure. However, DE102005048129B4 does not possess a load moment lock for rotary outputs, a restoring spring for one of the outputs of the differential gear or a threaded piece and provides only one housing upper part for all the drives. Without a load moment lock, therefore, only overbalanced tailgate mechanisms can be driven by means of this drive. The drive is therefore not suitable for lifting mechanisms, such as electric window lifters, blinds or tailgate drives. If a tailgate and a closure are to be actuated simultaneously by means of such a drive, the absence of a restoring spring constitutes a safety risk with regard to the closing of the closure.

Although DE102005048129B4 describes a ring wheel which can drive a closure via a Bowden cable, it nevertheless lacks a restoring spring which always brings the ring wheel into the exactly identical initial position. Without a specific restoring spring in the drive, the ring wheel can be turned back to the middle position only up to a specific angle even by high forces caused by the friction in the drive and in the Bowden cable. This leads to a reduced closing travel and, in the case of specific locks may even prevent complete closing.

A further disadvantage is to be seen in the fact that the drive system from DE102005048129B4 possesses only a rotary output which, moreover, is reduced once only. This drive system possesses no possibility for end-of-travel damping. If the tailgate moves up against a hard stop, load moment shocks therefore occur. The components of the drive must have a correspondingly large dimensioning and are therefore also more costly than is actually necessary.

The epicyclic gear illustrated, with only one planet, can be balanced only by single-plane balancing. A drive with this gear is therefore unsuitable for high rotational speeds.

Furthermore, German Laid Open Publication DE4318481A1 discloses a drive device with an electric drive motor, an armature shaft of the motor being selectively connected via a differential gear to a first or to a second output shaft, and each of these output shafts cooperating with another piece of equipment of a motor vehicle. However, the differential gear cannot be combined in a modular manner with a load moment lock or restoring spring or threaded piece and a suitable housing, in which a housing lower part always remains identical and only the housing upper part is adapted.

It is known, furthermore, that a simple and cost-effective load moment lock can be constructed by means of a volute spring. These load moment locks have the disadvantage, however, that the relation between the brake torque Mb and the coefficient of friction μ between the brake drum and volute spring is exponential. With regard to the cable friction and with a looping angle α S1/S2=ê(−μα) applies to the forces S1 and S2. This leads to extremely high fluctuations of the brake characteristic in series manufacture. Even if all the influencing variables have a very narrow tolerance, the coefficient of friction μ is subject, on account of wear and the aging of the lubricant, to fluctuations which cannot be predicted exactly. Accordingly, the brake action of a load moment lock with a volute spring will fluctuate to a much greater extent than the coefficient of friction μ. This may lead to the slipping of a load to be braked and therefore constitutes a safety risk. Since drives with load moment locks in automobiles are required in very large quantities, volute springs are not suitable here.

Moreover, it is known to lock load moments by means of self-locking gears. However, self-locking gears achieve only efficiencies of less than or equal to 50%. This makes the drives heavier and more costly than is necessary, since non-self-locking gears achieve markedly higher efficiencies of approximately 75%.

Motor vehicles nowadays have a multiplicity of motor drives which must fulfill diverse and completely different requirements. However, since the electric motors are mass-produced components, in which adaptations are possible to only a limited extent, the object of this invention is to make available a large number of drives and outputs with only a few components by means of a different combination. Drives which are required in very large quantities, in particular drive combinations for central locking systems, should in this case preferably contain only a few components.

Furthermore, the efficiency of the overwhelming majority of the drives and outputs should not be lower than 50%, but should remain markedly higher. The functioning of the load moment lock required for this purpose is in this case to be especially robust with regard to fluctuations in coefficient of friction, load moment fluctuations and component tolerances.

Typical functional requirements to be fulfilled by drives which are made available by the invented system of components are:
translational output movements
rotational output movements
activation of Bowden cables
reversible outputs
non-reversible outputs
outputs with end-of-travel damping
outputs without end-of-travel damping
outputs with single-stage reduction
outputs with two-stage reduction
power-split gears
non-power-split gears
motor drive with spring-driven return
spring-driven drive with motor return
purely motor setting and resetting.

These properties may be required in diverse combinations of a drive. Translational movements are to be capable of being produced via stable metal spindles, since high forces may act here. This space requirement of the overall drive should in this case remain as small as possible, even when, for example, only a single motor with V-drive is required. As a result of this, however, the number of housing parts required is not to be increased substantially.

According to the invention, the above object is achieved by means of the features of patent claim 1. Advantageous refinements of the drive system according to the invention are specified in the subclaims.

A drive system of the type initially mentioned is characterized by the following feature combinations:

to implement a basic drive, the gear wheel has a reversible thread with a non-self-locking pitch and with a positive connection for an output, a volute spring preferably being capable of being arranged in the gearwheel, the turns of which spring are wound around either on the left or on the right. To implement a load moment lock with a linear relation between the brake torque and coefficient of friction, furthermore, a control spring, a brake spring, an output and a brake ring are provided. The control spring may in this case be formed as a separate component or else be integrally formed onto the gearwheel or the output for example in the form of a flexural beam. Furthermore, to produce the most diverse drive and output combinations described in more detail below, different housing upper parts can be arranged on the drive system. Furthermore, in an especially preferred embodiment, a web, a stepped planet, a inner ring wheel and an outer ring wheel are provided for implementing a power-split gear.

Further aims, features, advantages and possibilities for use of the drive system may be gathered from the following description of an exemplary embodiment with reference to the drawings. In this case, all the features described and/or pictorially illustrated form the subject of the invention in themselves or in any combination, irrespective of the summary in individual claims or their back reference.

In the drawings:

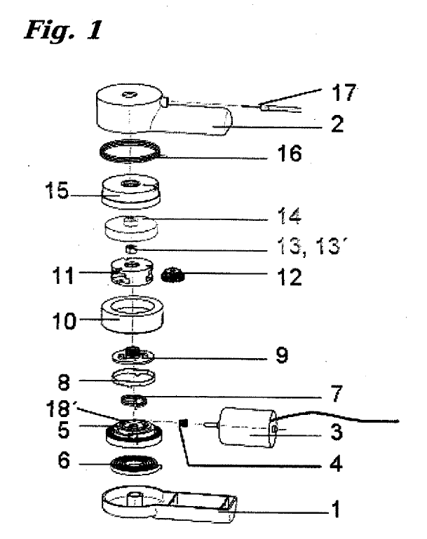

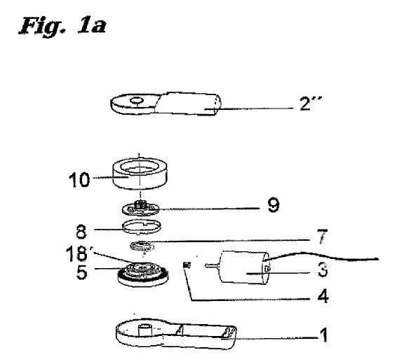

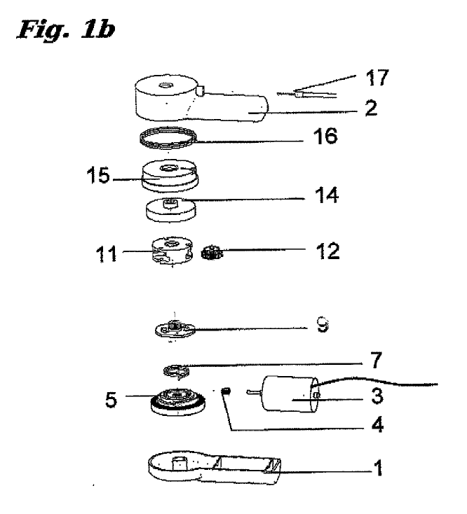

FIG. 1 shows an exploded illustration of the drive system with a maximum number of components,

FIG. 1a shows an exploded illustration of the drive system for a side window roller blind,

FIG. 1b shows an exploded illustration of the drive system for seat folding,

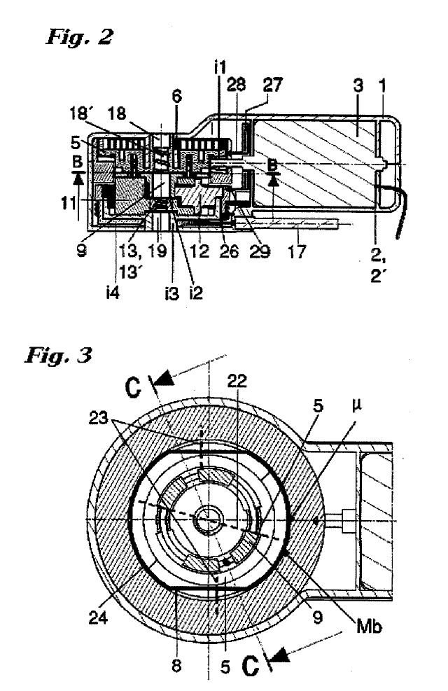

FIG. 2 shows a section through a drive system, as in FIG. 1,

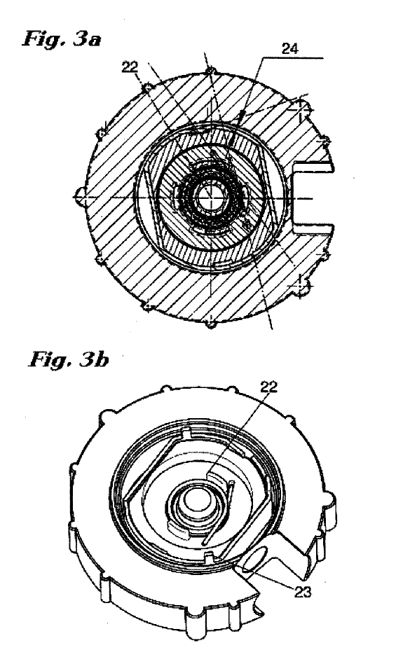

FIG. 3 and FIG. 3a show a section through the load moment lock,

FIG. 3b shows the load moment lock, as in FIG. 3, in a perspective view,

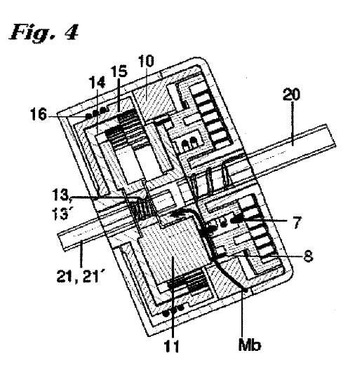

FIG. 4 shows a further section through the drive system,

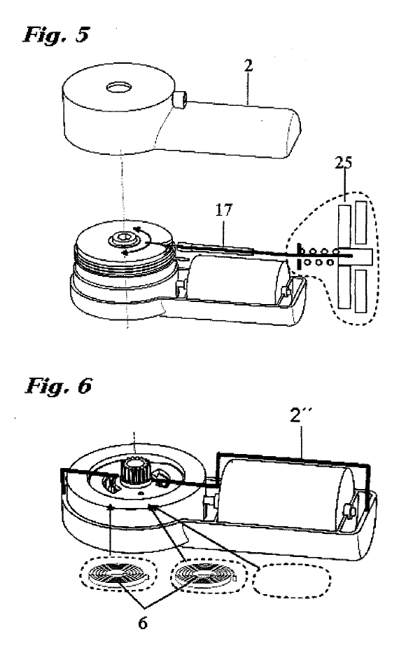

FIG. 5 shows the functioning of the Bowden cable 17 and of the closure 25,

FIG. 6 shows a section through the housing upper part 2″, which is required in the case of single-reduction drives with and without a load moment lock,

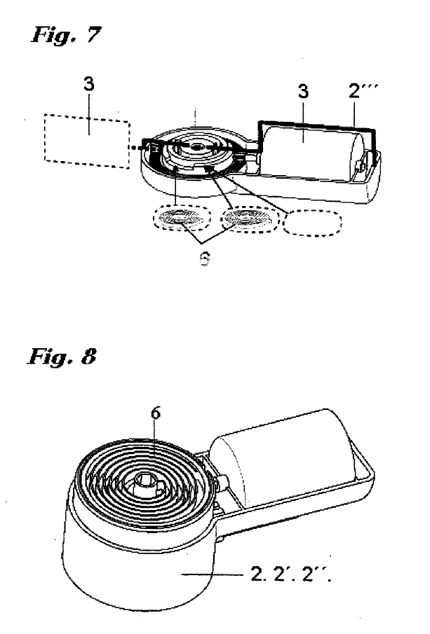

FIG. 7 shows a section through the housing upper part 2″, which is required in the case of single-reduction drives without a load moment lock,

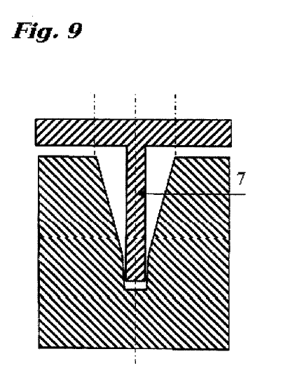

FIG. 8 shows the volute spring 6, mounted in the gearwheel 5, in one of two possible mounting positions,

FIG. 9 shows in table form the drive combinations A to K2 which can be arranged in a modular manner by means of the drive system according to the invention,

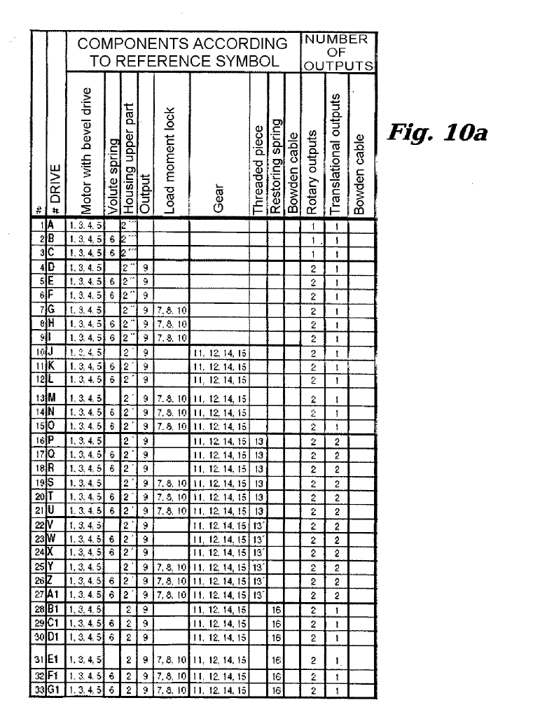

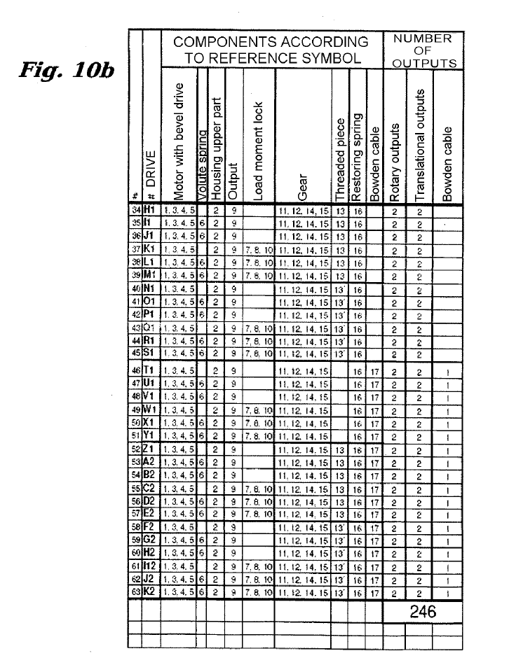

FIG. 10 shows the control spring 7 as a flexural beam between the gearwheel 5 and output.

FIG. 1 illustrates first all the components of a preferred embodiment of the drive system in an exploded illustration. What are illustrated are the housing lower part 1, the housing upper part 2, the motor 3, the pinion 4, the gearwheel 5 with a reversible thread 18′ having a non-self-locking pitch, a volute spring 6, a control spring 7, a brake spring 8, an output 9, a brake ring 10, a web 11, planets 12, threaded pieces 13 and 13′, an inner ring wheel 14, an outer ring wheel 15, a restoring spring 16 and a Bowden cable 17, all in a built-up assembly.

FIG. 2 illustrates the drive shown in FIG. 1 in section. The housing upper parts 2 and 2′ differ from one another only in the retaining rib 26 which is indicated in section. Furthermore, the reductions i1, i2, i3, i4 are illustrated. The single-reduction output 18 evident from FIG. 2 arises due to a positive connection in the gearwheel 5. The double-reduction output 19 arises due to a positive connection in the inner ring wheel 14.

The (single-reduction) basic drive of the drive system according to the invention consists of a housing lower part 1 and of a housing upper part 2′″ (see, in this respect, FIG. 7), into which at least one motor 3, in each case with a pinion 4 and with a gearwheel 5, is mounted. The gearwheel 5 possesses a thread 18′ with a non-self-locking pitch and with a positive connection for the output 18, so that both a reversible spindle and a rotary output can be driven by means of the drive system.

The gearwheel 5 advantageously has mounted in it a volute spring 6, the turns of which are wound around either on the left or on the right, thus giving rise to 3 different drives A, B, C. Each of these drives has two output possibilities B, C, a single-reduction rotary output 18 and a translational output for the drive of a reversing spindle 20. If, by contrast, no volute spring 6 is mounted, a simple gear motor A with single-stage reduction is obtained. If the volute spring 6 is mounted around on the left, this results in an unlocking drive B, which motor-drives in one direction and which returns, spring-driven, in the other direction as soon as the motor 3 is switched off. If the volute spring 6 is mounted around on the right, the drive C drives, spring-driven, in one direction and returns by motor in the other direction.

If one of these three drives A, B, C is combined with the output 9 and the housing upper part 2″′ is replaced by the housing upper part 2″, three further drives D, E, F are obtained, which possess a second rotary output on the other housing side, but still do not contain a load moment lock. The further drives D, E, F have in each case three output possibilities. Two rotary and one reversible translational 18. The housing upper parts 2, 2′, 2″, 2′″ may be varied so that a compact drive is always obtained. They nevertheless differ from one another often in only a few details, and therefore they can sometimes be produced via tool exchange inserts.

The load moment lock according to the invention, which is discussed in more detail in the following paragraph, arises as a result of the mounting of the control spring 7, brake spring 8, output 9 and brake ring 10, as components, in one of the drives D, E, F with the housing upper part 2″, thus giving rise again to three further drives which possess a single-stage reduction with a load moment lock. These drives G, H, I, too, have in each case three output possibilities.

To implement the load moment lock, when a load is being lifted the gearwheel 5 rotates the brake spring 8 in relation to the output 9 so that the brake spring 8 can be contracted. At the same time, during this operation, the control spring 7 is tensioned. This functions symmetrically in both directions. A gap therefore arises between the brake spring 8 and brake ring 10. The brake (consisting of the brake spring 8 and brake ring 10) is opened and runs freely. When the motor 3 is switched off, the torque in the brake is reversed. The control spring 7 then rotates the gearwheel 5 in relation to the output 9. As a result, the brake spring 8 is also rotated and is expanded until it comes to bear against the brake ring 10. The brake ring 10 should have such solidity that it can easily absorb and dissipate the heat occurring during braking. As a result of the low brake torque, the brake spring 8 is drawn increasingly into the brake gap 24 until the necessary brake torque is reached. In this case, the lubricating film between the brake spring 8 and brake ring 10 also generates a low torque, which is sufficient to close the brake, but not as dynamically as by means of the control spring 8. The load slips back only somewhat. Since the output must be connected fixedly to the rotation of the gearwheel 5 when no load moment lock is required, the output 9 can be inserted into two positions in relation to the gearwheel 5. On the one hand, fixedly to the rotation and, on the other hand, rotatable in both directions by the amount of the switching angle.

As is clear from FIG. 3 and FIGS. 3a, 3b, the stop 23 acts between the gearwheel 5 and brake spring 8. The stop 22 acts between the gearwheel 5 and output 9. In this position, the motor 3 drives the load directly via the stop 22. The gearwheel 5 takes up the brake spring 8 via the stop 23 in exactly the position such that the brake gap 24 occurs between the brake spring 8 and brake ring 10. FIG. 3 identifies the locations at which, on the one hand, the coefficient of friction μ occurs and, on the other hand, the brake torque Mb arises.

FIG. 4 illustrates how the control spring 7 has a restoring action to the middle position in both directions between the gearwheel 5 and the output 9. The control spring 7 may, depending on the size of the components, either be formed as a separate component, or else, as shown in FIG. 10, be integrally formed onto the gearwheel 5 or the output 9 in the form of a flexural beam. The output spindle 20 is driven by the gearwheel 5. The spindles 21 and 21′ are driven by the threaded pieces 13 and 13′. Furthermore, the run of the brake torque Mb through the gear is illustrated.

FIG. 5 explains clearly how a closure 25 can be actuated by means of the Bowden cable 17. In this case, the direction of rotation does not play any part. The Bowden cable 17 is always pulled first. The closure 25 then comes into abutment and the motor torque is transferred, for example, to the inner ring wheel 14 which can consequently, for example, drive a tailgate. The Bowden cable 17 can be mounted axially in a simple way. The reductions i1, i2, i3 and i4 are in this case selected so that a broad range of torques and forces is covered.

FIG. 6 shows a section through the housing upper part 2″, which is required in the case of single-reduction drives with and without a load moment lock.

FIG. 7 shows a section through the housing upper part 2′″, which is required in the case of single-reduction drives without a load moment lock and without an output 9. It is clear from this that it is possible also to use a plurality of motors 3 instead of one motor 3.

FIG. 8 shows the mounted volute spring 6 in the bevel wheel 5 in one of the two possible mounting positions.

Preferably, a gear, consisting of an outer ring wheel 15, of an inner ring wheel 14, of a web 11 and of a plurality of planets 12 (likewise illustrated in FIGS. 1, 2 and 4), can be placed onto the drives D, E, F and onto the drives G, H, I. The abovementioned drives consequently acquire a double-reduction rotary output 19.

This gear may be supplemented by the mounting of a threaded piece with a reversible thread pitch 13 or a threaded piece with a non-reversible pitch (blocking) 13′, to form two further variants. As a result, either a reversing spindle 21 or a non-reversing spindle 21′ can be driven via a double reduction. If, by contrast, none of the threaded pieces 13, 13′ is mounted, the drive combinations J, K, L, M, N, O, each with three output possibilities, are obtained.

By the threaded piece 13 with a reversible pitch being mounted, the combinations P, Q, R, S, T, U, likewise in each case with four output possibilities, are obtained.

By the blocking threaded piece 13′ being mounted, the drive combinations V, W, X, Y, Z, A1, each with four output possibilities, are obtained.

The drives J to A1 can be completed by means of the housing 2′ to form drives without a power-split gear.

The housing upper part 2′ contains a retaining rib 26 which blocks the outer ring wheel 15. This gives rise to drives with straightforward reduction gears without end-of-travel damping.

In another embodiment, the drives J to A1 are combined with a restoring spring 16 and with the housing 2. Drives with straightforward reduction gears, but with end-of-travel damping, are consequently obtained, thus resulting in a further 18 combinations B1 to S1.

In a further embodiment, the drives J to A1 are combined with a restoring spring 16 and the housing 2 and with the Bowden cable 17. This gives rise to drives with power-split gears. A further 18 drive combinations T1 to K2, each with five outputs, are obtained.

Overall, therefore, a total of 63 mechanical drive combinations, listed in the table in FIG. 10, with a maximum number of 19 components in a drive, are obtained. Overall, only 22 different components are required in order to produce all the possible drive combinations.

Each of the outputs 17, 18, 18′, 19, 20, 21, 21′ has different properties with regard to the form of movement, reduction, torque, force and reversibility.

In the drives A to K2, electronics 27 may be provided which (in each case) carry sensors 28, 29 both for the gearwheel 28 and for the outer ring wheel 29. The electronics 27 are able not only to detect the movement of the motor 3, but also to determine the position of the outer ring wheel 15 and therefore, indirectly, the state of a closure.

The stops 22 and 23 are located such that there is a brake gap 24 between the brake spring 8 and brake ring 10 when the load is being driven in both directions of rotation. If a volute spring 6 was mounted in one of the drives A to K2, the control spring 7 may instead be dispensed with, without the functioning of the load moment lock being impaired.

There are many different advantages of the drive system according to the invention and of the individual possibilities for the combination of each of the components thereof. It was very surprising to the person skilled in the art that none of the disadvantages mentioned arose any longer in all the drives described above.

Thus, drives with single, double and triple reduction can be constructed, as a result of which a broad range of use is covered. On account of the reversible thread 18′ in the gearwheel 5, simple unlocking drives without a load moment lock and without a differential can be constructed for the opening of locks. Faults in the drive or in the control electronics can no longer have an adverse effect on the closing function of the closure, since the drive is mechanically self-resetting and can also be reversed by the closure.

The unlocking drives have two components fewer than the drives customary at the present time, thus saving costs and increasing the functional reliability. The drives may selectively contain load moment locks, without this leading to losses in overall efficiency. This advantage is reflected either in the weight or in the costs. When a load is being driven, a small gap, which rules out rubbing noises, arises between the brake spring 8 and brake ring 10. If the motor 3 is stopped in downward travel, the control spring 7 and lubricant ensure that braking is initiated quickly, in that they rotate the brake spring 8 somewhat and press it against the brake ring 10. In this case, the control spring 7 acts upon the brake spring 8 as a back-up to the adjusting moment caused by the lubricant and, depending on the viscosity of the lubricant, may have a low-strength design.

The control spring 7 may even be dispensed with entirely if there is no need for a rapid response behavior of the lock when the load is stopped in downward travel, and if there is suitable lubricant and a sufficiently small brake gap 24. The control spring 7 may therefore also be designed, as illustrated in FIG. 9, as a flexural beam which is integrally formed either onto the gearwheel 5 or onto the output 9. When the load is being braked, the brake spring 8 of the load moment lock is drawn into the brake gap until the required brake torque is reached. This leads to a broad load range in which the lock functions, without brake springs of different dimensioning being required. Component tolerances or component wear therefore also have no effects on functioning. The load moment lock can be lubricated, and changes in the coefficient of friction act only linearly and not exponentially on the brake torque.

Furthermore, the differential can be balanced completely and is therefore also suitable for high rotational speeds and torques. The restoring spring 16 of the differential may, depending on the housing upper part, act as a restoring spring 16 or as end-of-travel damping. The restoring spring 16 makes it possible with only one motor 3 to drive both the load and the closure of the load, without there being a safety risk for the closing function of the closure. Two drives were previously necessary for this purpose. The restoring spring 16 also makes it possible to open closures which have only a very low-strength closing spring which, without a restoring spring 16, would be too weak to reverse the drive.

The drive system according to the invention is not restricted in its implementation to the preferred embodiments specified above. On the contrary, a multiplicity of design variations may be envisaged which make use of the solution illustrated even in a version which is basically of another type.

### LIST OF REFERENCE NUMERALS

1 Housing lower part
2 Housing upper part with Bowden cable
2′ Housing upper part with no Bowden cable
2″ Housing upper part without a gear with a load moment lock
2″′ Housing upper part without a gear without a load moment lock
3 Motor
4 Pinion
5 Gearwheel
6 Volute spring
7 Control spring
8 Brake spring
9 Output
10 Brake ring
11 Web
12 Planets
13 Threaded piece, reversing
13′ Threaded piece, blocking
14 Inner ring wheel
15 Outer ring wheel
16 Restoring spring
17 Bowden cable
18 Output with single reduction
18′ Non-self-locking thread
19 Output with double reduction
20 Spindle, reversing
21 Spindle, reversing
21′ Spindle, blocking
22 Stop X
23 Stop Y
24 Brake gap
25 Closure
26 Retaining rib
27 Electronics
28 Sensor, gearwheel
29 Sensor, outer ring wheel
i1 Reduction, bevel drive
i2 Reduction, web
i3 Reduction, inner ring wheel
i4 Reduction, outer ring wheel
μ Coefficient of friction
Mb Brake torque

1.-18. (canceled)

19. A drive system consisting of components than can be combined in a modular manner and from which a multiplicity of drives and outputs with different properties can be provided, each combination of the components containing in each case a housing lower part, at least one motor and a reduction gear consisting of a pinion and of a bevel wheel, different housing upper parts being capable of being provided, which can be arranged on the drive system in order to implement different drives and outputs, and, furthermore, to implement a power-split gear, a web, an inner ring wheel and an outer ring wheel being provided, wherein,
a) to implement a basic drive, the bevel wheel has a thread with a non-self-locking pitch and with a positive connection for a rotary output,
b) to implement a load moment lock with a linear relation between the brake torque and coefficient of friction, a control spring, a flexural spring, an output and a brake ring are provided, the load moment lock having a linearly rising or falling brake torque, in which the relation between the brake torque and coefficient of friction is linear and not exponential, so that fluctuations in the coefficient of friction are in effect only linearly and not exponentially, upon the brake torque,
c) and a restoring spring can be arranged on the outer ring wheel, the effect of which restoring spring is that a return of the outer ring wheel is brought about at any time independently of the position of the inner ring wheel,
d) a Bowden cable being capable of being arranged on the outer ring wheel, by which Bowden cable a closure can be actuated.

20. The drive system as claimed in claim 19, wherein the control spring is integrally formed as a flexural beam onto the gearwheel and/or as a flexural beam onto the output.

21. The drive system as claimed in claim 19, wherein the drive system is combined with a threaded piece with a non-reversible pitch, in order to drive a spindle.

22. The drive system as claimed in claim 19, wherein a volute spring can be arranged in the gearwheel, the turns of which volute spring are wound around either on the left or on the right.

23. The drive system as claimed in claim 19, wherein a reversible spindle is provided, which is driven by the gearwheel and in which the thread pitch is of such a size that no self-locking occurs.

24. The drive system as claimed in claim 19, wherein stops are arranged so that a brake gap occurs between the brake spring and brake ring when a load is being driven in both directions of rotation.

25. The drive system as claimed in claim 19, wherein a retaining rib which blocks the outer ring wheel is provided on the housing upper part.

26. The drive system as claimed in claim 19, wherein a double-reduction output arises due to a positive connection in the inner ring wheel.

27. The drive system as claimed in claim 19, wherein the drive system is combined with a threaded piece with reversible pitch, in order to drive a spindle.

28. The drive system as claimed in claim 19, wherein the drive system is combined with a threaded piece with a non-reversible pitch, in order to drive a spindle.

29. The drive system as claimed in claim 19, wherein the reductions are configured so a maximum torque/rotational speed range is covered by means of the rotary outputs.

30. The drive system as claimed in claim 19, wherein the reductions, and the pitches of the threaded pieces and also the pitch of the thread in the gearwheel are configured so that a maximum force/speed range is covered by means of the translational outputs.

31. The drive system as claimed in claim 19, wherein electronics are provided.

32. The drive system as claimed in claim 30, wherein the electronics contain a sensor for detecting the gearwheel movement and/or a sensor for detecting the outer ring wheel.

33. The drive system as claimed in claim 19, wherein the outer ring wheel and/or the gearwheel have/has integrally formed and/or magnetically configured markings which can be detected by the sensors.

34. The drive system as claimed in claim 19, wherein the brake ring is configured so that it is used as a cooling body for the electronic components.
